(19) United States
(12) Patent Application Publication
(10) Pub. No.: US 2015/0181169 A1
(43) Pub. Date: Jun. 25, 2015

(54) SECURITY DEVICE, BROADCAST RECEIVING DEVICE, CAMERA DEVICE, AND IMAGE CAPTURING METHOD THEREOF

(71) Applicant: SAMSUNG ELECTRONICS CO., LTD., Suwon-si (KR)

(72) Inventors: Tae-hoon KIM, Suwon-si (KR); Tae-hyeun HA, Suwon-si (KR)

(73) Assignee: SAMSUNG ELECTRONICS CO., LTD., Suwon-si (KR)

(21) Appl. No.: 14/333,590

(22) Filed: Jul. 17, 2014

(30) Foreign Application Priority Data
Dec. 19, 2013 (KR) 10-2013-0159364

(51) Int. Cl. H04N 7/18; H04N 5/225; H04N 5/265; H04R 1/02

(52) U.S. Cl. CPC H04N 7/18; H04R 1/028; H04N 5/2254; H04N 5/265; H04R 2499/11

(57) ABSTRACT

A security device includes an interface configured to be connected to a camera, a storage configured to store reference audio data, a microphone configured to receive a sound input and convert the sound input into audio data, and a controller configured to, in response to the converted audio data corresponding to the reference audio data, activate the camera.

### CROSS-REFERENCE TO RELATED APPLICATIONS

This application claims priority from Korean Patent Application No. 10-2013-0159364, filed in the Korean Intellectual Property Office on Dec. 19, 2013, the disclosure of which is incorporated herein by reference in its entirety.

### BACKGROUND

1. Field

Aspects of the exemplary embodiments relate to a security device, a broadcast receiving device, and an image photographing method of a broadcast receiving apparatus, and more particularly, to a security device which photographs an external image by operating a camera by external sound, a broadcast receiving device, and an image photographing method of a broadcast receiving apparatus.

2. Description of the Related Art

In general, a house or a company installs and uses a door phone system to control the entrance. Most of the houses and companies which use such a door phone system have the indoor device of the door phone in the inside of the house or company and have the outdoor device in the entrance, and the two devices are connected to each other.

According to the conventional door phone system, a camera for photographing the outside of the entrance is activated by an electrical signal triggered by a bell button pressed by a visitor, the image photographed by the activated camera is transmitted to the indoor device, and a display panel included in the indoor device displays the received image. Accordingly, a user who is inside may check the visitor or the outside circumstances.

However, the conventional door phone system has a configuration in which a bell button and a camera installed outside, a bell speaker for setting off sound by the bell button, and a display panel for displaying an external image photographed by the camera are formed in an integrated manner. Thus, it is costly to install a new door phone system, and the new system may not be compatible with the previously-installed bell button.

In addition, the indoor device of the conventional door phone system is fixed to a specific location that is usually decided when a house or a building is initially designed. Accordingly, a user who is in the inside of the house or the building may have difficulties in checking a visitor or outside circumstances.

### SUMMARY

An aspect of the exemplary embodiments relates to a security device which photographs an external image by a camera operated by external sound without replacing the previous bell device or system, a broadcast receiving device, and an image photographing method of a broadcast receiving apparatus.

A security device according to an exemplary embodiment includes an interface configured to be connected to a camera, a storage configured to store reference audio data, a microphone configured to receive a sound input and convert the sound input into audio data, and a controller configured to, in response to the converted audio data corresponding to the reference audio data, activate the camera.

The device may further include a display, wherein the camera captures an image, and wherein the controller is further configured to control the display to display the captured image.

The controller may be further configured to, in response to the display being in an inactivated state, activate the display and control the display to display the captured image on at least one area of a display area of the display.

The controller may be further configured to, in response to a main screen is displayed on the display, add a Picture In Picture (PIP) area in the main screen and display the captured image on the PIP area.

The device may further include a communicator configured to perform communication with an external display device, and the controller may be further configured to control the communicator to transmit the captured image to the external display device and control the display to display the captured image.

The reference audio data may include audio data that is generated by converting at least one of a doorbell sound, a voice sound, and a knocking sound.

The controller may be further configured to store the captured image in the storage.

A broadcast receiving device according to an exemplary embodiment includes a receiver configured to receive a broadcast signal, a signal processor configured to process the broadcast signal, a display, an interface configured to be connected to a camera, a storage configured to store reference audio data, a microphone configured to receive external sound and convert the sound into audio data, and a controller configured to, when the converted audio data corresponds to the reference audio data, control the camera to active and capture an image and control the display to display the captured image on at least one area of the display, wherein the reference audio data is generated by converting at least one of a doorbell sound, a voice sound, and a knocking sound.

An image capturing method of a broadcast receiving device according to an exemplary embodiment includes converting, in response to a sound being input, the sound into audio data; capturing, in response to the converted audio data corresponding to the reference audio data, an image by activating a camera connected to the broadcast receiving device; and displaying the captured image.

The method may further include activating, in response to the image being captured while a display of the broadcast receiving device is in an inactivated state, the display.

The method may further include adding, in response to the image being captured while a main screen is displayed on a display of the broadcast receiving device, a Picture-in-Picture (PIP) area in the main screen, wherein the captured image is displayed on the PIP area.

The reference audio data may be generated by converting at least one of a doorbell sound, a voice sound, and a knocking sound.

The method may further include storing the captured image.

A camera device according to an exemplary embodiment includes a camera; a storage configured to store reference audio data; a microphone configured to receive a sound input and convert the sound input into audio data; and a controller configured to, in response to the converted audio data corresponding to the reference audio data, activate the camera and control the camera to capture an image.

The camera device may further include an interface configured to communicate with a display device. The controller may be further configured to, in response to the converted audio data corresponding to the reference audio data, control the interface to transmit the captured image to the display device.

The controller may be further configured to control the generation of the reference audio data by converting at least one among a doorbell sound, a voice sound, and a knocking sound, and to control the storage to store the reference audio data.

The capturing an image may be capturing a video.

An image capturing method of a camera device according to an exemplary embodiment includes converting an input sound into audio data; comparing the converted audio data to reference audio data; activating a camera in response to the converted audio data corresponding to the reference audio data; and capturing image with the activated camera.

The method may further include transmitting the captured image to a display device in response to the converted audio data corresponding to the reference audio data.

The method may further include generating the reference audio data by converting at least one among a doorbell sound, a voice sound, and a knocking sound, and storing the reference audio data.

According to the above-described various exemplary embodiments, the previously-installed doorbell device or system may be interlocked and thus, the cost for establishing a security system may be reduced. In addition, a user may observe outside circumstances conveniently.

### BRIEF DESCRIPTION OF THE DRAWINGS

The above and/or other aspects of one or more exemplary embodiments will be more apparent by describing certain exemplary embodiments with reference to the accompanying drawings, in which:

FIG. 1 illustrates an example of a structure of a security system according to an exemplary embodiment;

FIG. 2 illustrates an example of a block diagram of a security device according to an exemplary embodiment;

FIG. 3 illustrates another example of a block diagram of a security device according to an exemplary embodiment;

FIG. 4 illustrates yet another example of a block diagram of a security device according to an exemplary embodiment;

FIG. 5 illustrates an example of a screen displayed by a security device according to an exemplary embodiment;

FIG. 6 illustrates another example of a screen displayed by a security device according to an exemplary embodiment;

FIG. 7 illustrates an example of a block diagram of a broadcast receiving device according to an exemplary embodiment;

FIG. 8 illustrates an example of a screen displayed by a broadcast receiving device according to an exemplary embodiment;

FIG. 9 illustrates various examples of a screen displayed by a broadcast receiving device according to an exemplary embodiment;

FIG. 10 is a flowchart of an image photographing method according to an exemplary embodiment;

FIG. 11 illustrates an example of a block diagram of a configuration of a broadcast receiving device according to an exemplary embodiment in an comprehensive manner; and

FIG. 12 illustrates an example of a block diagram of a camera device according to an exemplary embodiment.

### DETAILED DESCRIPTION

It should be observed the method steps and system components have been represented by conventional symbols in the figure, showing only specific details which are relevant for an understanding of the present disclosure. Further, details that are readily apparent to persons ordinarily skilled in the art may not be discussed. In the present disclosure, relational terms such as first and second, and the like, may be used to distinguish one entity from another entity, without necessarily implying any actual relationship or order between such entities.

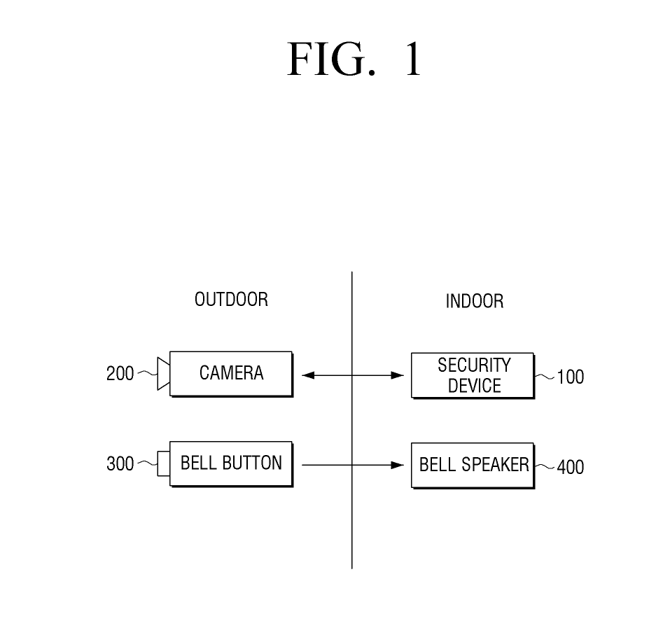

FIG. 1 illustrates an example of a structure of a security system according to an exemplary embodiment.

Referring to FIG. 1, a security system according to an exemplary embodiment may be divided in to indoor devices and outdoor devices. A camera 200 and a bell button 300 are located inside, and a bell speaker 400 and a security device 100 are located outside.

The bell button 300 is located at a place where a user wishes to control or monitor, for example an entry or entryway, and sets off a sound signal to request a user inside to release entry control, such as unlocking a door. That is, the bell button 300 may be a general doorbell. The bell speaker 400 sets off a sound corresponding to a sound signal triggered by the bell button 300. The sound may be a bell sound.

Meanwhile, the bell button 300 may be connected to the bell speaker 400 which is located inside via a cable or wirelessly. Accordingly, if a visitor presses the bell button 300, an electrical signal is generated and the signal is transmitted to the bell speaker 400. The bell speaker 400 which receives the electrical signal triggered by the bell button 300 sets off the bell sound. In this case, the bell sound may have an audible frequency which can be heard by a user, and the volume of the sound may be adjusted by the user.

The camera 200 is located at a place where a user wishes to control an entry, and captures an image around the place. The capturing an image may be, as non-limiting examples, photographing, recording video. In this case, a plurality of cameras 200 may be disposed, and each of the cameras may be disposed in various areas where the user wishes to control an entry so that the user may be provided with external circumstances in detail.

The security device 100 activates the camera 200 by the bell sound generated by the bell speaker 400. In this case, the security device 100 may be connected to the camera 200 via a cable or wirelessly. In addition, the security device 100 may be disposed at a place where a user controlling an entry is located.

First of all, the security device 100 may store reference audio data corresponding to the bell sound generated by the bell speaker 400. In this case, the reference audio data may be audio data which is converted from the bell sound.

Subsequently, if a visitor presses the bell button 300, the bell speaker 400 sets off the bell sound. The security device 100 inputs the bell sound generated by the bell speaker 400 and converts the bell sound into audio data. The security device 100 compares the converted audio data with stored reference audio data to see whether they correspond to each other. If it is determined that the converted audio data and the stored reference audio data are correspond to each other, the security device 100 may transmit a wake-up signal to activate the camera 200 to the camera 200. The camera 200 which receives the wake-up signal photographs the area where the camera 200 is disposed and the surrounding areas and transmit the photographed images to the security device 100. Accordingly, the security device 100 may display visual information regarding the circumstances of areas where the user wishes to control or monitor an entry.

Meanwhile, the above-described camera 200 is provided only to explain an exemplary embodiment. That is, according to various exemplary embodiments, the camera 200 may be disposed not only in the outside of a door but also in other places that the user wishes to control and monitor, such as windows of a house, a building, a factory, a veranda, an external wall, a warehouse, or other inside or outside areas.

In addition, the above-described bell button 300 and the bell speaker 400 are only examples, and the security device 100 does not necessarily receive only bell sound generated by the bell speaker 400. That is, the security device 100 may receive a sound signal from a sound sensing device disposed at an area where the camera 200 is located or from other types of sound generating devices which may receive a sound signal from a sound sensing device and output the signal in the form of an audible frequency. Alternatively, the sound generating devices may receive a sound signal from a sound sensing device and output the signal in the form of an inaudible frequency.

Hereinafter, the security device will be described in detail.

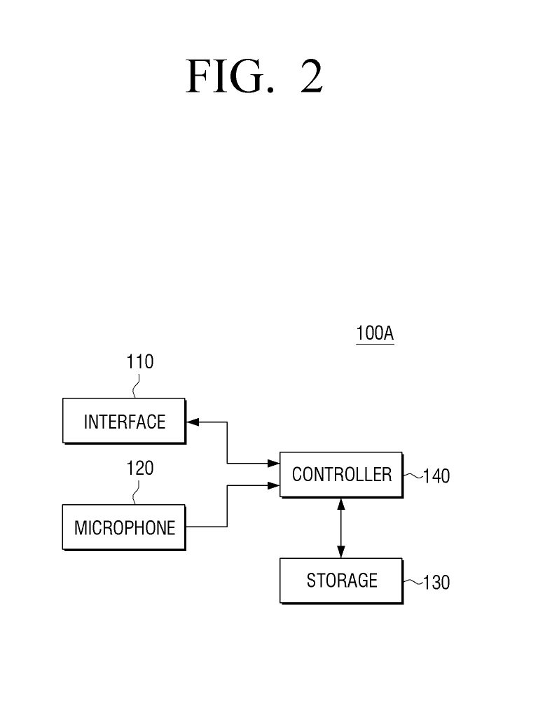

FIG. 2 illustrates an example of a block diagram of a security device 100A according to an exemplary embodiment. Referring to FIG. 2, the security device 100A includes an interface 110, a microphone 120, a storage 130, and a controller 140.

A user may set a specific sound to activate the camera 200 and may store the sound which is generated at a place where the user wishes to control an entry or sound which is generated at a place where the user wishes to monitor in the storage 130 in advance. Accordingly, the user may generate sound to be stored in the storage 130, the sound may be at least one of a doorbell sound, a voice sound, a knock sound, etc.

The microphone 120 inputs the above-generated sound and converts the sound into audio data. The controller 140 may store the converted audio data in the storage 130, and the audio data stored in the storage 130 becomes reference audio data. In this case, the reference audio data may be generated by converting at least one of the doorbell sound, the voice sound, and the knock sound. For example, if a user wishes to activate the camera 200 by the output sound of the bell speaker 400, the audio data which is converted from the output sound of the bell speaker 400 at an initial setting stage may be set as reference audio data and stored in the storage 130. In addition, the controller 140 may store a plurality of pieces of reference audio data in the storage 130. Accordingly, the initialization setting of the security device 100A may be completed. Subsequently, the microphone 120 inputs sound which can be received at a place where the microphone 120 is located and converts the sound into audio data. The converted audio data is transmitted to the controller 140, and the controller 140 determines whether the reference audio data stored in the storage 130 corresponds to the converted audio data.

The controller 140 controls overall operations of the security device 100A. In particular, if the converted audio data corresponds to the reference audio data, the controller 140 may control an activation of the camera 200 to photograph an image. In addition, the controller 140 may receive an image photographed by the camera 200 and store the image in the storage 130.

The interface 110 performs communication with various types of external apparatuses according to various types of communication methods. In particular, the interface 110 is connected to the camera 200 via a cable or wirelessly, and transmits/receives a signal between the controller 140 and the camera 200. The interface 110 may include a WiFi chip, a Bluetooth chip, a wireless communication chip, and Near Field Communication (NFC) chip.

The controller 140 generates a wake-up signal to activate the camera 200 and transmits the signal to the camera 200 through the interface 110. The inactivated camera 200 may be activated as it receives the wake-up signal from the controller 140 through the interface 110, and the activated camera 200 photographs an image around the area where the camera 200 is located. The images photographed by the camera 200 are transmitted to the controller 140 through the interface 110, and the controller 140 may store photographed images in the storage 130.

Meanwhile, FIG. 2 illustrates a case where the microphone 120 is built inside the security device 100A, but this is only an example. The microphone 120 may be disposed in a place which is different from where the controller 140 is located and may be connected to the controller 140 via a cable or wirelessly.

For example, the microphone 120 and the controller 140 may be a first area and a second area respectively which are separated from each other, and may be connected to each other via a cable or wirelessly. The microphone 120 may input sound, which is generated by, as non-limiting examples, the bell speaker 400, a user voice, and the vibration of object, and convert the sound to audio data. In this case, the first area may be an area corresponding to a window, a veranda, an external wall, a warehouse, other indoor or outdoor area that a user wishes to monitor, and the second area may be an area corresponding to a place where the user is located while monitoring or controlling entry to the first area.

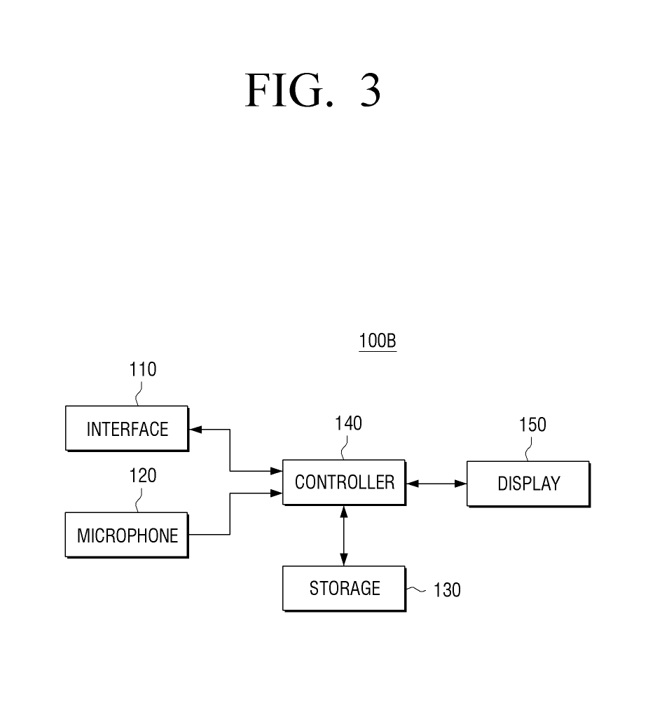

FIG. 3 illustrates another example of a block diagram regarding a security device 100B according to an exemplary embodiment. Hereinafter, the description which is overlapped with the description regarding FIG. 2 will not be provided. Referring to FIG. 3, the security device 100B according to an exemplary embodiment may further include a display 150.

The display 150 is connected to the controller 140 and performs an operation under the control of the controller 140. In particular, the display 150 displays an image photographed by the camera 200.

That is, the microphone 120 inputs sound and converts the sound into audio data, and if it is determined that the converted audio data corresponds to the reference audio data stored in the storage 130, the controller 140 transmits a wake-up signal to the camera 200 through the interface 110. The camera 200 which receives the wake-up signal photographs surrounding images and transmits the images to the controller 140, and the controller 140 displays the received surrounding images on the display 150. Further, the controller 140 may store the received surrounding images in the storage 130.

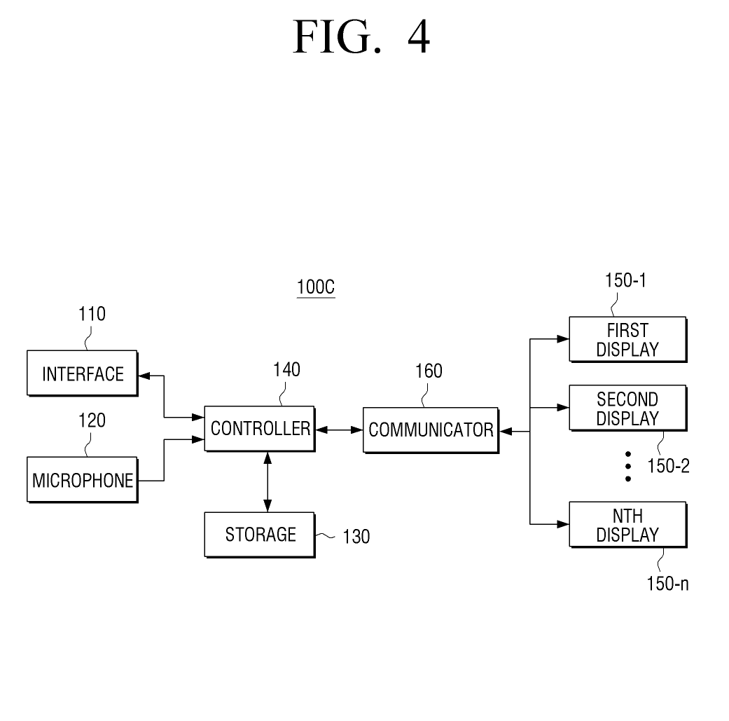

Meanwhile, FIG. 3 illustrates a case where the display 150 is mounted on the security device 100B, but this is only an example. The display 150 may be disposed in an area which is different from where the controller 140 is located and may be connected to the controller 140 via a cable or wirelessly. In particular, the display 150 and the controller 140 may be disposed in the first area and the second area respectively which are separated from each other, and may be connected to each other wirelessly, which will be described in detail with reference to FIG. 4.

FIG. 4 illustrates yet another example of a block diagram of a security device 100C according to an exemplary embodiment. Hereinafter, the description of elements shared with the description regarding FIGS. 2 to 3 will not be provided. Referring to FIG. 4, the security device 100C according to an exemplary embodiment may further include the communicator 160, and may be disposed apart from the controller 140.

The communicator 160 performs communication with the display which is disposed apart from the controller 140, and may perform communication with various types of displays according to various types of communication methods. In particular, the communicator 160 may be connected to the controller 140 via a cable or wirelessly and transmits/receives a signal between the controller 140 and the display. In particular, the communicator 160 may include a WiFi chip, a Bluetooth chip, a wireless communication chip, and an NFC chip.

That is, the microphone 120 inputs sound and converts the sound into audio data, and if it is determined that the converted audio data corresponds to the reference audio data stored in the storage 130, the controller 140 transmits a wake-up signal to the camera 200 through the interface 110. The camera 200 which receives the wake-up signal captures surrounding images and transmits the images to the controller 140, and the controller transmits the received surrounding images to a display through the communicator 160 so that the surrounding images can be displayed on the display. In this case, the controller 140 may store the received surrounding images in the storage 130.

Meanwhile, as illustrated in FIG. 4, there may be a plurality of displays. A plurality of displays 150-1, 150-2, . . . , and 150-n which are disposed apart from the controller 140 may perform communication with the communicator 160. In this case, each of the plurality of displays 150-1, 150-2, . . . , and 150-n may be disposed in different areas.

Herein, the interface 110 may perform communication with one camera 200. In this case, the controller 140 may transmit surrounding images photographed by the camera 200 to the plurality of displays 150-1, 150-2, . . . , and 150-n through the communicator 160, and each of the plurality of displays 150-1, 150-2, . . . , and 150-n may display the surrounding images photographed by the camera 200. Each of the plurality of displays 150-1, 150-2, . . . , and 150-n is disposed in a different area and displays the surrounding images photographed by the camera 200 and thus, a user does not have to move to a single place where the security device 100C is installed to monitor the location of the camera 200.

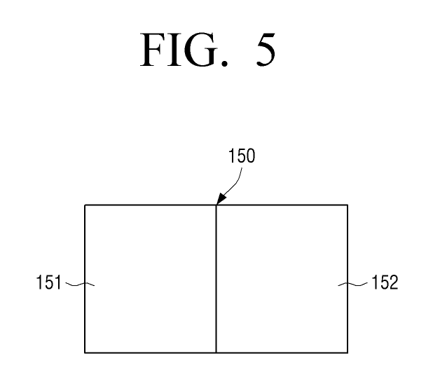

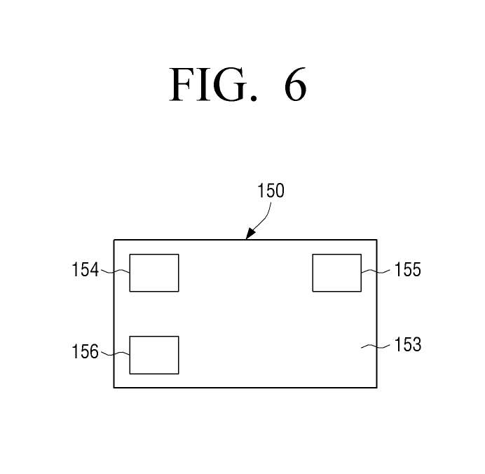

FIGS. 5 and 6 illustrate various examples of a screen displayed by the security device 100C according to an exemplary embodiment.

The interface 110 may perform communication with a plurality of cameras 200, and each of the plurality of cameras 200 may be disposed in different areas. In addition, one display screen may be divided into a plurality of display areas. Accordingly, the controller 140 which receives surrounding images from at least one camera 200 may activate an inactivated display, and display the received surrounding images on at least one display area.

The display may display a plurality of screens. As illustrated in FIG. 5, as a non-limiting example, one display screen may be divided into a first area 151 and a second area 152 which are arranged in left and right directions. That is, the controller 140 may display a first surrounding image received from the first camera 200 on the first area 151, and may display a second surrounding image received from the second camera 200 on the second area 152. FIG. 5 illustrates a case where one display screen is divided in vertical direction, but this is only an example. One display screen may be divided into in the horizontal, diagonal, or other direction so that a plurality of screens can be displayed.

In this case, the location of the camera 200 corresponding to each display area may be described in each display area. As shown above, if the first camera 200 in the entrance photographs the first surrounding image, the first area 151 may display the first surround image along with the text, “entrance”, on one side of the screen.

Meanwhile, the display may display a main screen and at least one sub screen. As a non-limiting example, as illustrated in FIG. 6, the entire screen of the display may be provided as a main area 153, and a sub area in the form of Picture In Picture (PIP) may be added in the main area 153. In this case, the sub area may be formed on the edge of the main area.

In addition, there may be a plurality of sub areas 154, 155, and 156, and the plurality of sub areas 154, 155, and 156 may correspond to a plurality of surrounding images photographed by the plurality of cameras 200. For example, the first surrounding image may correspond to the main area 153, the second surrounding image may correspond to the first sub area 154, the third surrounding image may correspond to the second sub area 155, and the fourth surrounding image may correspond to the third sub area 156, respectively. Accordingly, if the controller 140 receives the second surrounding image while the first surrounding image is displayed on the main area 153, the controller 140 may display the second surrounding image on the first sub area 154 Likewise, if the controller 140 receives the second surrounding image first from among a plurality of surrounding images, the controller 140 may display the second surrounding image on the first sub area 154. If the controller 140 receives the first surrounding image while the second surrounding image is displayed on the first sub area 154, the controller 140 may display the first surrounding image on the main area 153.

Further, the main area 153 and the sub areas 154, 155, and 156 may correspond to the order the surrounding images are received. That is, the surrounding image which is received first from among a plurality of surrounding images may be displayed on the main area 153, and the surrounding image which is received next may be displayed on the first sub area 154. For example, if the controller 140 receives the third surrounding image first from among a plurality of surrounding images, the controller 140 may display the third surrounding image on the main area 153. If the controller 140 receives the second surrounding image while the third surrounding image is displayed on the main area 153, the controller 140 may display the second surrounding image on the first sub area 154. If the controller 140 receives the first surrounding image while the second surrounding image is displayed on the first sub area 154, the controller 140 may display the first surrounding image on the second sub area 155.

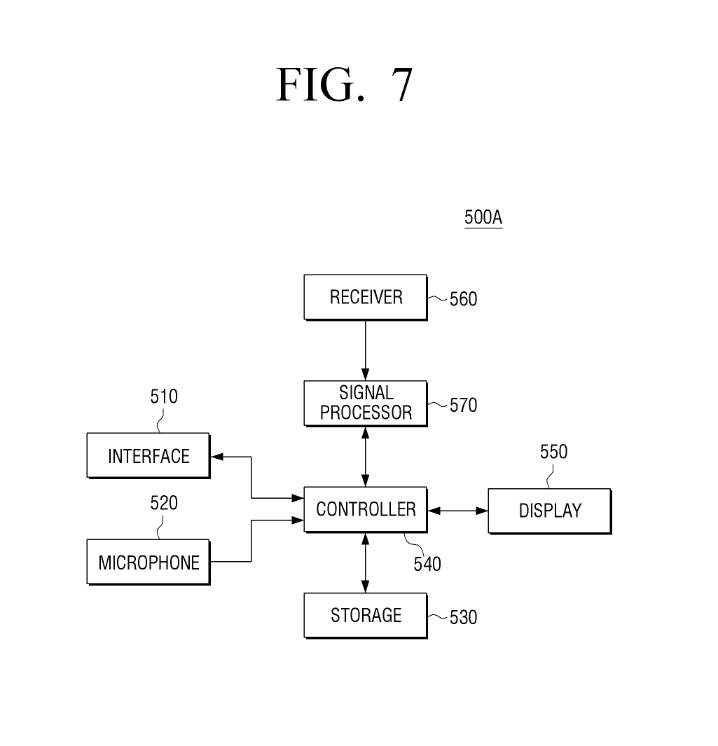

FIG. 7 illustrates an example of a block diagram of a broadcast receiving device 500A according to an exemplary embodiment. Referring to FIG. 7, the broadcast receiving device 500A according to an exemplary embodiment includes a receiver 560, a signal processor 570, an interface 510, a microphone 520, a storage 530, a controller 540, and a display 550.

The receiver 560 receives a broadcast signal. The receiver 560 may be realized as various types of devices such as the broadcast receiving device 500A like set-top box, television, mobile phone, PDA, set-top PC, PC, notebook PC, kiosk, etc.

The signal processor 570 processes a broadcast signal. The signal processor 570 processes a broadcast signal which the receiver 560 receives and converts the signal into video data, audio data and other data. If the receiver 560 receives a broadcast signal, the signal processor 570 performs signal processing such as demodulation, equalization, de-multiplexing, de-interleaving, decoding, etc., with respect to the received broadcast signal, and generates a video frame and an audio frame.

The display 550 displays a broadcast content which is processed by the signal processor 570. The controller 540 outputs the video frame generated by the signal processor 570 to the display 550. As the method for receiving and displaying a broadcast signal by the receiver 560, the signal processor 570, and the display 550 are known, detailed description thereof will not be provided.

Meanwhile, the storage 530 stores audio data which is generated by converting specific sound to activate the camera 200. The sound to activate the camera 200 may be at least one of a doorbell sound, a voice sound, and a knock sound.

The microphone 520 receives such sound as input and converts the sound into audio data. The controller 54 may store the converted audio data in the storage 530, and the audio data stored in the storage 530 becomes reference audio data. In this case, the reference audio data may be generated by converting at least one of the doorbell sound, the voice sound, and the knock sound. In addition, the controller 540 may store a plurality of pieces of reference audio data in the storage 530.

The controller 540 controls overall operations of the broadcast receiving device 500A. In particular, the controller 540 compares the audio data that the microphone 520 receives and converts with the reference audio data stored in the storage 530 to see whether they correspond to each other.

The interface 510 performs communication with various types of external apparatuses according to various types of communication methods. In particular, the interface 510 is connected to the camera 200 via a cable or wirelessly, and transmits/receives a signal between the controller 540 and the camera 200.

Accordingly, if the converted audio data corresponds to the reference audio data, the controller 540 may control the camera 200 to activate and capture an image. The controller 540 generates a wake-up signal to activate the camera 200, and transmits the signal to the camera 200 through the interface 510. The inactivated camera 200 may be activated as it receives the wake-up signal from the controller 540 through the interface 510, and the activated camera 200 photographs images around the area where the camera 200 is located. The surrounding images photographed by the camera 200 are transmitted to the controller 540 through the interface 510 and displayed through the display 550. In this case, the controller 540 may store the photographed surrounding images in the storage 530.

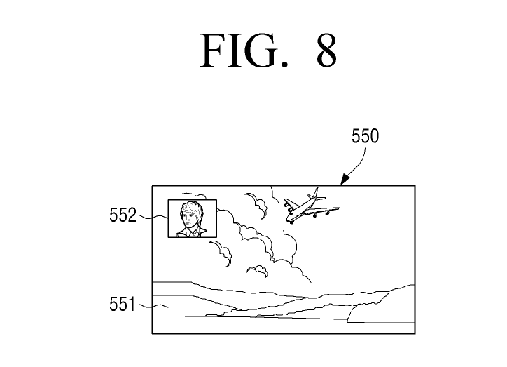

FIG. 8 illustrates an example of a screen displayed by the broadcast receiving device 500A according to an exemplary embodiment.

The broadcast receiving device 500A according to an exemplary embodiment may display a main screen and at least one sub screen. As illustrated in FIG. 8, the entire screen of one display may be provided as a main area 551, and a sub area 552 in the form of Picture In Picture (PIP) may be added in the main area 551. In this case, the sub area 552 may be formed on the edge of the main area 551.

If the broadcast receiving device 500A is turned on, a screen according to a broadcast signal is displayed on the main area 551. In this case, the sub area 552 may not be generated.

Subsequently, if the sound signal that the microphone 520 receives corresponds to the reference audio data stored in the storage 530, the sub area 552 is formed on one side of the main area 551. Accordingly, the controller 540 displays the screen according to the broadcast signal on the main area 551 while displaying the surrounding images received by the activated camera 200 on the sub area 552.

FIG. 8 illustrates a case where the broadcast receiving device 500A is turned on, and a screen according to a broadcast signal is displayed, but this is only an example. Hereinafter, a case where the broadcast receiving device 500A is turned off will be described.

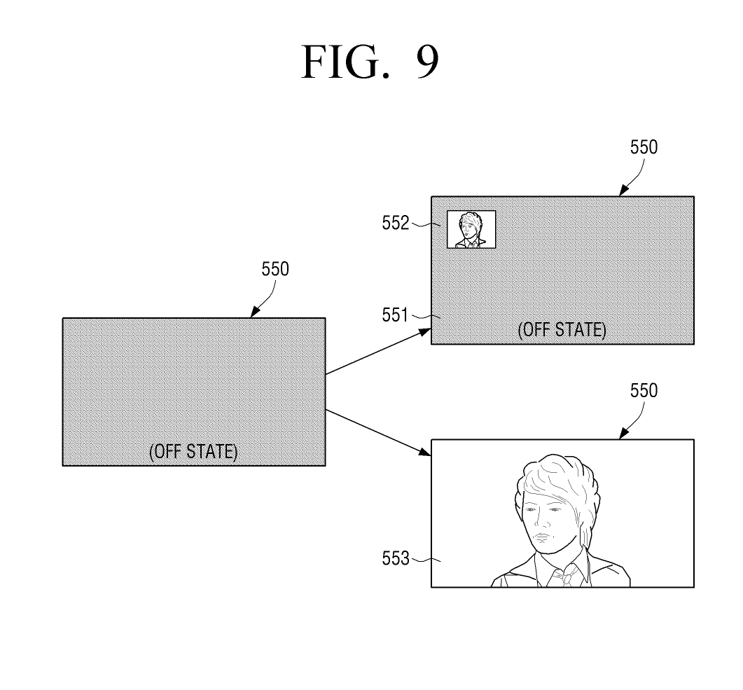

FIG. 9 illustrates various examples of a screen displayed by the broadcast receiving device 500A according to an exemplary embodiment.

Referring to FIG. 9, the broadcast receiving device 500A is in a turn-off state, so a broadcast signal is not received and the display 550 is in a turn-off state. Herein, the turn-off state refers to a soft power off state or a standby mode where power is turned off by the power button of the broadcast receiving device 500A rather than a hard power off state where power is not supplied to the power supply (not shown) of the broadcast receiving device 500A.

In this state, if the sound signal that the microphone 520 receives corresponds to the reference audio data stored in the storage 530, the sub area 552 is newly formed on one side of the main area 551. The newly formed sub area 552 displays surrounding images photographed by the camera 200 which is activated by the controller 540. In this case, the broadcast receiving device 500A does not receive a broadcast signal and thus, nothing is displayed on the main area 551, and the surrounding images are displayed only on the sub area 552.

Meanwhile, while the broadcast receiving device 500A is turned off, the surrounding images photographed by the camera 200 may be displayed on the main area 553 rather than a sub area. That is, if the sound signal that the microphone 520 receives corresponds to the reference audio data stored in the storage 530, the main area 553 displays the surrounding images photographed by the camera 200 which is activated by the controller 540. In this case, if the broadcast receiving device 500A does not receive a broadcast signal, the main area 553 may display only the surrounding images.

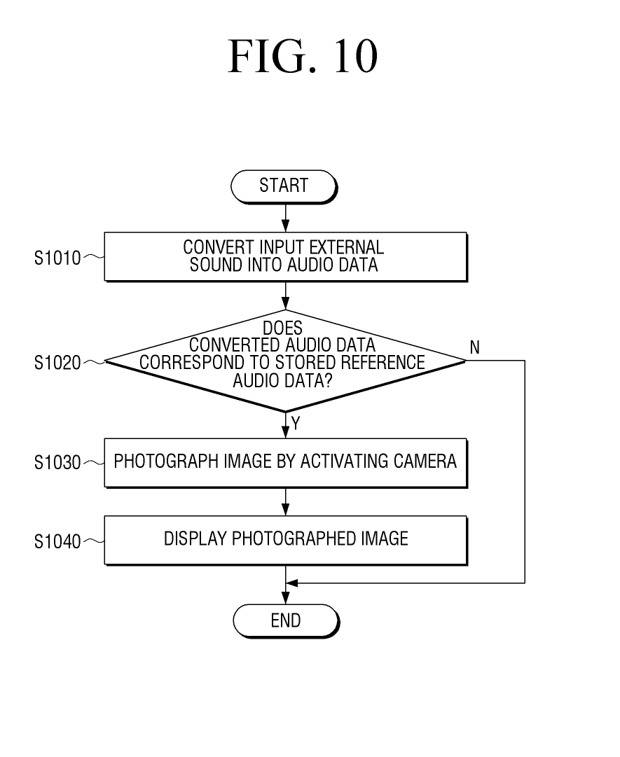

FIG. 10 is a flowchart of an image photographing method of the broadcast receiving device 500A according to an exemplary embodiment.

First of all, sound which is generated at a place where a user wishes to control an entry or sound which is generated at a place where the user wishes to monitor should be stored in the storage 530 in advance. The microphone 520 receives such sound as input and converts the sound into audio data. The controller 540 may store the converted audio data in the storage 530, and the audio data stored in the storage 530 becomes reference audio data. In this case, the reference audio data may be generated by converting at least one of a doorbell sound, a voice sound, and a knock sound. According to the above method, the initialization setting of the security device can be completed.

Subsequently, when external sound is input, the microphone 520 converts the sound into audio data (S1010). The converted audio data is transmitted to the controller 540, and the controller 540 determines whether the reference audio data stored in the storage 530 corresponds to the converted audio data (S1020).

If the converted audio data corresponds to the reference audio data (S1020_Y), the controller 540 transmits a wake-up signal which activates the inactivated camera 200 to the camera 200. The camera 200 which receives the wake-up signal from the controller 540 is activated and photographs surrounding images. That is, the controller 540 activates the camera 200 and photographs images (S1030).

Subsequently, the controller 540 receives the photographed images from the camera 200, and the received photographed images are displayed through the display 550 (S1040). In this case, the display 550 is in an inactivated state, the controller 540 may activate the display 550 to display the photographed images. In addition, the controller 540 may receive the images photographed by the camera 200 and store the photographed images in the storage 530.

If the converted audio data does not correspond to the reference audio data (S1020_N), the controller does not activate the camera. Although the camera 200 has been generally described as photographing an image, this is merely an example, and the camera 200 may, for example, capture a video or a plurality of images.

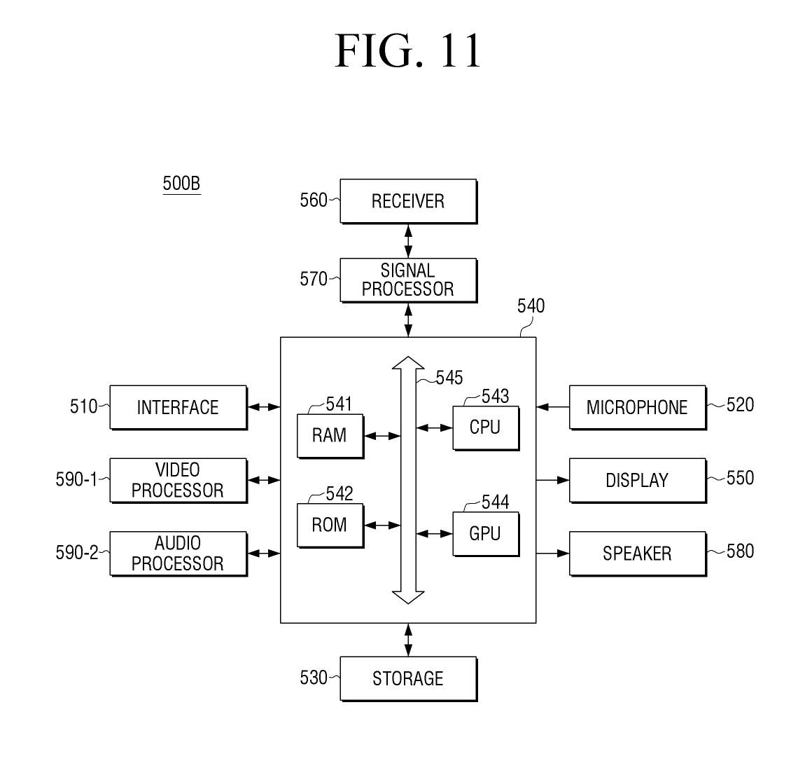

FIG. 11 illustrates an example of a block diagram provided to explain configuration of a broadcast receiving device 500B according to an exemplary embodiment in an comprehensive manner. Hereinafter, the description of elements shared with the description regarding FIG. 7 will not be provided.

As illustrated in FIG. 11, the broadcast receiving device 500B according to an exemplary embodiment may include a receiver 560, a signal processor 570, a controller 540, a storage 530, an interface 510, a video processor 590-1, an audio processor 590-2, a display 550, a microphone 520, and a speaker 580.

The receiver 560 receives a broadcast signal. The receiver 560 may be realized as various types of devices such as the broadcast receiving device 500A like a set-top box, a television, a mobile phone, a PDA, a set-top PC, a PC, a notebook PC, a kiosk, etc.

The signal processor 570 processes a broadcast signal which the receiver 560 receives and converts the signal into video data, audio data and other data. If the receiver 560 receives a broadcast signal, the signal processor 570 performs signal processing such as demodulation, equalization, de-multiplexing, de-interleaving, decoding, etc. with respect to the received broadcast signal and generates a video frame and an audio signal. The generated video frame is provided to the display 550, and the audio signal is provided to the speaker 580.

The storage 530 stores various programs and data necessary to perform operations of a display device. In particular, the storage 530 stores audio data which is generated by converting a specific sound to activate the camera 200. In this case, the specific sound may be at least one of a doorbell sound, a voice sound, and a knock sound. In addition, the storage 530 may store the surrounding images photographed by the camera 200.

The controller 540 controls overall operations of the broadcast receiving device 500B. The controller 540 includes a random access memory (RAM) 541, a read only memory (ROM) 542, a central processing unit (CPU) 543, a graphics processing unit (GPU) 544, and a bus 545. The RAM 541, the ROM 542, the CPU 543, the GPU 544, etc., may be connected to each other through the bus 545.

The CPU 543 accesses the storage 530, and performs booting using O/S stored in the storage 530. Various operations are performed by using various programs, contents, data, etc. stored in the storage 530. In addition, it is determined whether the reference audio data stored in the storage 530 corresponds to the audio data received by the microphone 520. In addition, a wake-up signal to activate the camera 200 is generated and transmitted to the camera 200 through the interface 510.

The ROM 542 stores a set of commands for system booting. If a turn-on command is input and power is supplied, the CPU 543 copies an O/S stored in the storage 530 onto the RAM 541 according to a command stored in the ROM 542 and boots a system by executing the O/S. If the booting is completed, the CPU 543 copies various application programs stored in the storage 530 onto the RAM 541 and performs the various operations by executing the application programs copied in the RAM 541.

When the booting of the display device is completed, the GPU 544 displays a screen such as an item screen, a content screen, a search result screen, etc. Specifically, the GPU 544 may generate a screen including various objects such as an icon, an image, and a text using a computing unit (not shown) and a rendering unit (not shown). The computing unit computes property values such as coordinates, shape, size, and color of each object to be displayed according to the layout of the screen. The rendering unit generates a screen with various layouts including objects based on the property values computed by the computing unit. The screen generated by the rendering unit is provided to the display 550, and is displayed within the display area. Meanwhile, the GPU 544 displays the surrounding images that the camera 200 receives on the display screen.

The interface 510 performs communication with various types of external apparatuses according to various types of communication methods. The interface 510 may include a WiFi chip, a Bluetooth chip, a wireless chip, and an NFC chip.

The WiFi chip and the Bluetooth chip perform communication according to a WiFi method and a Bluetooth method, respectively. In the case of the WiFi chip or the Bluetooth chip, various connection information such as SSID and a session key may be transmitted/received first for communication connection and then, various information may be transmitted/received. The wireless communication chip represents a chip which performs communication according to various communication standards such as IEEE, Zigbee, 3rd Generation (3G), 3rd Generation Partnership Project (3GPP), Long Term Evolution (LTE) and so on. The NFC chip represents a chip which operates according to an NFC method which uses 13.56 MHz band among various RF-ID frequency bands such as 135 kHz, 13.56 MHz, 433 MHz, 860-960 MHz, 2.45 GHz, and so on.

The video processor 590-1 processes surrounding images received through the interface 510 and/or video data included in a broadcast signal received through the receiver 560. That is, the video processor 590-1 may perform various image processing with respect to video data, such as decoding, scaling, noise filtering, frame rate conversion, resolution conversion, etc. In this case, the display 550 may display an image frame generated by the video processor 590-1.

The audio processor 590-2 processes audio data included in a broadcast signal received through the receiver 560. The audio processor 590-2 may perform various processing with respect to audio data, such as decoding, amplification, noise filtering, etc.

The display 550 displays various screens as described above. The display 550 may be realized in various types of displays such as Liquid Crystal Display (LCD), Organic Light Emitting Diodes (OLED) display, Plasma Display Panel (PDP), etc. The display 550 may include a diving circuit, a backlight unit, etc. which may be realized in the form of a-si TFT, Low Temperature Poly Silicon (LTPS) TFT, Organic TFT (OTFT), etc.

The speaker 580 outputs audio data generated by the audio processor 590-2.

The microphone 520 receives a user voice or other sound and converts the voice or the other sound into audio data. The controller 540 compares sound input through the microphone 520 with pre-stored sound to perform a control operation regarding the camera 200, or may convert the sound into audio data and store the data in the storage 530. In particular, if the microphone 520 is provided, the controller 540 may compare the sound received through the microphone 520 with the sound stored in the storage 530, and if it is determined that the received sound corresponds to the stored sound, may perform a control operation accordingly.

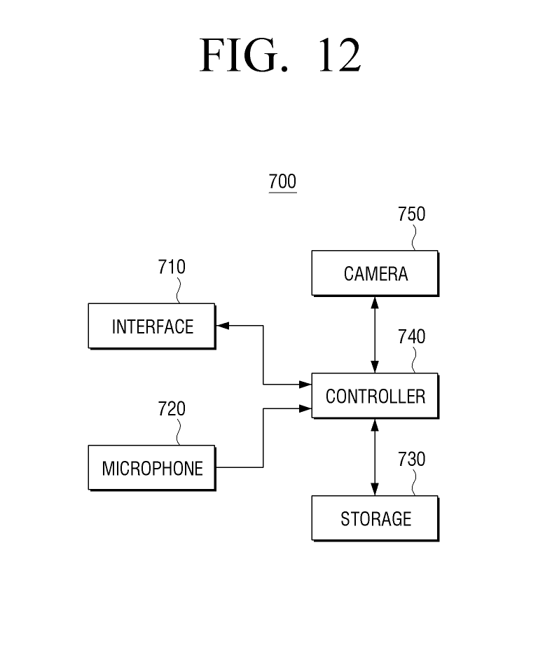

FIG. 12 illustrates an example of a block diagram of a camera device 700 according to an exemplary embodiment. Referring to FIG. 12, the camera device 700 includes an interface 710, a microphone 720, a storage 730, a controller 740, and a camera 750.

The microphone 720 may receive a sound as input and convert the sound into audio data. The audio data may be compared to reference audio data stored in the storage 730.

The controller 740 may control, in response to the audio data corresponding to the reference audio data, the camera 750 to activate and capture an image. The interface 710 may communicate with an external apparatus and transmit the captured image to the external apparatus. The external apparatus may be, as non-limiting examples, a television, a mobile phone, or a personal computer.

The controller 740 may control the generation of the reference audio data by converting at least one among a doorbell sound, a voice sound, and a knocking sound, and control the storage to store the reference audio data.

The image photographing method according to various exemplary embodiments may be stored in a non-transitory readable medium. The non-transitory readable medium may be mounted in various apparatuses and used therein. For example, a program code to perform a method including, when external sound is input, converting the sound into audio data, when the converted audio data corresponds to reference audio data, activating a camera connected to a broadcast receiving device to photograph images, and displaying the photographed images may be stored in a non-transitory readable medium and provided therein.

The non-transitory recordable medium refers to a medium which may store data semi-permanently rather than storing data for a short time such as a register, a cache, and a memory and may be readable by an apparatus. Specifically, the non-transitory readable medium may be CD, DVD, hard disk, Blu-ray disk, USB, memory card, ROM, etc.

The foregoing embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A security device, comprising:
an interface configured to be connected to a camera;
a storage configured to store reference audio data;
a microphone configured to receive a sound input and convert the sound input into audio data; and
a controller configured to, in response to the converted audio data corresponding to the reference audio data, activate the camera.

2. The security device as claimed in claim 1, further comprising:
a display,
wherein the camera captures an image, and
wherein the controller is further configured to control the display to display the captured image.

3. The security device as claimed in claim 2, wherein the controller is further configured to, in response to the display being in an inactivated state, activate the display and control the display to display the captured image on at least one area of a display area of the display.

4. The security device as claimed in claim 2, wherein the controller is further configured to, in response to a main screen being displayed on the display, add a Picture In Picture (PIP) area in the main screen and displays the captured image on the PIP area.

5. The security device as claimed in claim 1, further comprising:
a communicator configured to perform communication with an external display device,
wherein the controller is further configured to control the communicator to transmit the captured image to the external display device and to control a display of the external display device to display the captured image.

6. The security device as claimed in claim 1, wherein the reference audio data comprises audio data that is generated by converting at least one of a doorbell sound, a voice sound, and a knocking sound.

7. The security device as claimed in claim 1, wherein the controller is further configured to store the captured image in the storage.

8. A broadcast receiving device, comprising:
a receiver configured to receive a broadcast signal;
a signal processor configured to process the broadcast signal;
a display;
an interface configured to be connected to a camera;
a storage configured to store reference audio data;
a microphone configured to receive a sound input and convert the sound into audio data; and
a controller configured to, in response to the converted audio data corresponding to the reference audio data, control the camera to activate and capture an image and control the display to display the captured image on at least one area of the display,
wherein the reference audio data is generated by converting at least one of doorbell sound, voice sound and knock sound.

9. An image capturing method of a broadcast receiving device, comprising:
converting, in response to a sound being input, the sound into audio data;
capturing, in response to the converted audio data corresponding to the reference audio data, an image by activating a camera connected to the broadcast receiving device; and
displaying the captured image.

10. The image capturing method as claimed in claim 9, further comprising:
activating, in response to the image being captured while a display of the broadcast receiving device is in an inactivated state, the display.

11. The image capturing method as claimed in claim 9, further comprising:
adding, in response to the image being captured while a main screen is displayed on a display of the broadcast receiving device, a Picture-in-Picture (PIP) area in the main screen,
wherein the captured image is displayed on the PIP area.

12. The image capturing method as claimed in claim 9, wherein the reference audio data is generated by converting at least one of a doorbell sound, a voice sound, and a knocking sound.

13. The image capturing method as claimed in claim 9, further comprising:
storing the captured image.

14. A camera device, comprising:
a camera;
a storage configured to store reference audio data;
a microphone configured to receive a sound input and convert the sound input into audio data; and
a controller configured to, in response to the converted audio data corresponding to the reference audio data, activate the camera and control the camera to capture an image.

15. The camera device according to claim 14, further comprising:
an interface configured to communicate with a display device, wherein the controller is further configured to, in response to the converted audio data corresponding to the reference audio data, control the interface to transmit the captured image to the display device.

16. The camera device according to claim 14, wherein the controller is further configured to control the generation of the reference audio data by converting at least one among a doorbell sound, a voice sound, and a knocking sound, and to control the storage to store the reference audio data.

17. The camera device according to claim 14, wherein the capturing an image comprises capturing a video.

18. An image capturing method of a camera device, the image capturing method comprising:
converting an input sound into audio data;
comparing the converted audio data to reference audio data;
activating a camera in response to the converted audio data corresponding to the reference audio data; and
capturing an image with the activated camera.

19. The image capturing method of claim 18, further comprising:
transmitting the captured image to a display device in response to the converted audio data corresponding to the reference audio data.

20. The image capturing method of claim 18, further comprising generating the reference audio data by converting at least one among a doorbell sound, a voice sound, and a knocking sound, and storing the reference audio data.
